(19) United States
(12) Patent Application Publication
(10) Pub. No.: US 2007/0217787 A1
(43) Pub. Date: Sep. 20, 2007

(54) Photosensitive material processing apparatus

(75) Inventor: Koji Itoh, Kanagawa (JP)

Correspondence Address: TAIYO CORPORATION, 401 HOLLAND LANE, #407, ALEXANDRIA, VA, 22314, US

(73) Assignee: FUJIFILM CORPORATION

(21) Appl. No.: 11/703,638

(22) Filed: Feb. 8, 2007

(30) Foreign Application Priority Data
Mar. 14, 2006 (JP) 2006-068819

(51) Int. Cl. G03D 3/08

(52) U.S. Cl. 396/622

(57) ABSTRACT

A photosensitive material processing apparatus including: plural processing chambers sectioned by partition wall(s); a housing provided in the partition wall(s); a processing space that is communicated with the processing chambers and that stores a processing liquid; a flow-in side processing liquid exchange unit that is provided at the housing, and that enables the processing liquid to flow-in from the processing chamber to the processing space, in order to exchange the processing liquid stored in the processing space; and a flow-out side processing liquid exchange unit that is provided at the housing, and that enables the processing liquid to flow-out from the processing space to the processing chamber, in order to exchange the processing liquid stored in the processing space, and the flow-in and flow-out side processing liquid exchange units being arranged one on each side of the conveyance path on which the photosensitive material is conveyed.

### CROSS-REFERENCE TO RELATED APPLICATION

This application claims priority under 35 USC 119 from Japanese Patent Application No. 2006-068819, the disclosure of which is incorporated by reference herein.

### BACKGROUND

1. Technical Field

The present invention relates to a photosensitive material processing apparatus which performs development processing by conveying a photosensitive material such as a film and a color paper into processing tanks storing processing liquids.

2. Related Art

In a photosensitive material processing apparatus (automatic development apparatus) such as a film processor and a printer processor used in a laboratory or the like, development processing is performed by conveying a photosensitive material such as a film and a color paper into storing processing liquids such as a color developing liquid, a bleaching/fixing liquid, and a washing water.

In such a photosensitive material processing apparatus, it is proposed to employ a so-called double blade submerged processing system, wherein: housings inside of which is formed a processing space which stores a processing liquid, are provided in partition walls between plural processing chambers arranged in a processing tank; a photosensitive material is carried in/out of these processing spaces to be passed and conveyed through the conveyance path; the gateway of the conveyance path is liquid-tightly sealed by a pair of sealing devices (blades) which allow only the photosensitive material to pass but restrict the circulation of the processing liquid; and further the processing liquid in the processing space can be exchanged by means of a pair of processing liquid changing devices (check valves) arranged on the opposite ends of the processing space in the longitudinal direction, so as to improve the processing efficiency, to stabilize the treatment performance, to speed up the processing and miniaturize the apparatus by simplifying the conveyance route, to reduce the component, and to reduce the cost (for example, refer to Japanese Patent Application Laid-Open No. 2004-310061).

However, since the processing liquid in the processing tank has a concentration gradient from the upstream to the downstream including the above processing space, sufficient effects may not be obtained in the structure where the processing liquid changing devices are arranged on the opposite ends of the processing space in the longitudinal direction. For example, even if the processing liquid flows from the end of the flow-in side to the end of the flow-out side in the processing space, when it simply flows, the processing liquid is not mixed with a stored liquid in the processing space. In the worst scenario, the processing liquid on the upstream side that has flown into the processing space flows to the downstream side having the same concentration, and sufficient replacement may not be performed. Therefore, there is some room for further improvement from the point of improving the processing efficiency and stabilizing the treatment performance.

### SUMMARY

The present invention takes the above circumstances into consideration, and provides a photosensitive material processing apparatus which can realize a further improvement in the processing efficiency and a further stabilization of the treatment performance.

A first aspect of the present invention is to provide a photosensitive material processing apparatus including: a processing tank storing a processing liquid for processing a photosensitive material; plural processing chambers that are provided in the processing tank and sectioned by partition wall(s); a housing provided in the partition wall(s); a processing space that is provided inside the housing and that is communicated with the processing chambers through a conveyance path along which the photosensitive material is passed and conveyed, the processing space storing the processing liquid; a pair of seal units which are respectively provided on a photosensitive material carry-in side and on a photosensitive material carry-out side of the conveyance path, and which provide a liquid-tight seal between the processing space and the processing chambers, while enabling the photosensitive material to pass through; a flow-in side processing liquid exchange unit that is provided at the housing, and that enables the processing liquid to flow-in from the processing chamber to the processing space, in order to exchange the processing liquid stored in the processing space; a flow-out side processing liquid exchange unit that is provided at the housing, and that enables the processing liquid to flow-out from the processing space to the processing chamber, in order to exchange the processing liquid stored in the processing space; and the flow-in and flow-out side processing liquid exchange units being arranged one on each side of the conveyance path.

Another aspect of the present invention is to provide a photosensitive material processing apparatus including: a processing tank storing a processing liquid for processing a photosensitive material; plural processing chambers that are provided in the processing tank and sectioned by partition wall(s); a housing provided in the partition wall(s); a processing space that is provided inside the housing and that is communicated with the processing chambers through a conveyance path along which the photosensitive material is passed and conveyed, the processing space storing the processing liquid; a pair of seal units which are respectively provided on a photosensitive material carry-in side and on a photosensitive material carry-out side of the conveyance path, and which provide a liquid-tight seal between the processing space and the processing chambers, while enabling the photosensitive material to pass through; a flow-in side processing liquid exchange unit of a that is provided at the housing, and that enables the processing liquid to flow-in from the processing chamber to the processing space, in order to exchange the processing liquid stored in the processing space; a flow-out side processing liquid exchange unit of a that is provided at the housing, and that enables the processing liquid to flow-out from the processing space to the processing chamber, in order to exchange the processing liquid stored in the processing space; the flow-in and flow-out side processing liquid exchange units are arranged one on each side of the conveyance path; the flow-in and flow-out side processing liquid exchange units are arranged in substantially diagonal positions of the cross-sectional longitudinal direction of the conveyance path; the flow direction of the processing liquid at the processing liquid exchange units is substantially parallel to or substantially orthogonal to the conveyance direction in which the photosensitive material is conveyed on the conveyance path; the processing liquid exchange units are check valves, and the valve body of the check valves is urged onto a valve seat, by a force generated due to a difference in specific gravity of the valve body to that of the processing liquid, to be closed; and separates from the valve seat due to a difference in liquid pressure between the upstream side and the downstream side, to be opened; if the processing liquid is circulated upward through the check valve, specific gravities are set such that A/B is 1.0 or more but less than 1.5, or 0.6 or more but less than 1.0, wherein the specific gravity of the valve body is A and the specific gravity of the processing liquid is B; and the conveyance direction of the photosensitive material is substantially horizontal, and the flow direction at the check valves is substantially vertical, and when the processing liquid flows downward through the check valves, the valve body of the flow-out side is arranged downward with respect to the valve body of the flow-in side and on the other side of the conveyance path.

Other aspects, features and advantages of the present invention will become apparent from the following description taken in conjunction with the accompanying drawings.

### BRIEF DESCRIPTION OF THE DRAWINGS

FIG. 1 is a front cross-sectional view showing a processing tank mainbody provided in a photosensitive material processing apparatus according to a first exemplary embodiment of the present invention.

FIG. 2 is a front cross-sectional view showing a processing unit with a squeezing function which conveys a photosensitive material downward, according to the first exemplary embodiment of the present invention.

FIG. 3 is a plan cross-sectional view taken along the line 3-3 of FIG. 2 showing the processing unit with a squeezing function which conveys the photosensitive material downward, according to the first exemplary embodiment of the present invention.

FIG. 4 is a main part exploded perspective view showing a carry-in side housing member in the processing unit with a squeezing function of FIG. 2 and FIG. 3.

FIG. 5 is an enlarged plan view showing the main part of the processing unit with a squeezing function of FIG. 2 and FIG. 3 viewed from the side of the carry-in side housing member.

FIG. 6A is an enlarged vertical cross-sectional view showing a closed state of a check valve provided in the processing unit with a squeezing function of FIG. 2 and FIG. 3.

FIG. 6B is an enlarged vertical cross-sectional view showing an open state of the check valve provided in the processing unit with a squeezing function of FIG. 2 and FIG. 3.

FIG. 7 is a front cross-sectional view showing the processing unit with a squeezing function which conveys the photosensitive material upward, according to the first exemplary embodiment of the present invention.

FIG. 8A is an enlarged vertical cross-sectional view showing a closed state of a check valve provided in the processing unit with a squeezing function of FIG. 6.

FIG. 8B is an enlarged vertical cross-sectional view showing an open state of the check valve provided in the processing unit with a squeezing function of FIG. 6.

FIG. 9 is a front cross-sectional view showing a processing tank mainbody provided in a photosensitive material processing apparatus according to a second exemplary embodiment of the present invention.

FIG. 10A is a front cross-sectional view showing a processing unit with a squeezing function according to the second exemplary embodiment of the present invention, in the state where check valves are closed.

FIG. 10B is a front cross-sectional view showing the processing unit with a squeezing function according to the second exemplary embodiment of the present invention, in the state where the check valves are opened.

FIG. 11 is a side cross-sectional view taken along the line 11-11 of FIG. 10A showing the processing unit with a squeezing function according to the second exemplary embodiment of the present invention.

FIG. 12A is a front cross-sectional view showing a processing unit with a squeezing function according to a third exemplary embodiment of the present invention, in the state where check valves are closed.

FIG. 12B is a front cross-sectional view showing the processing unit with a squeezing function according to the third exemplary embodiment of the present invention, in the state where the check valves are opened.

FIG. 13 is a side cross-sectional view taken along the line 13-13 of FIG. 12A showing the processing unit with a squeezing function according to the third exemplary embodiment of the present invention.

Hereunder is a description of a photosensitive material processing apparatus (automatic development apparatus) according to the exemplary embodiments of the present invention, with reference to the drawings.

### FIRST EXEMPLARY EMBODIMENT

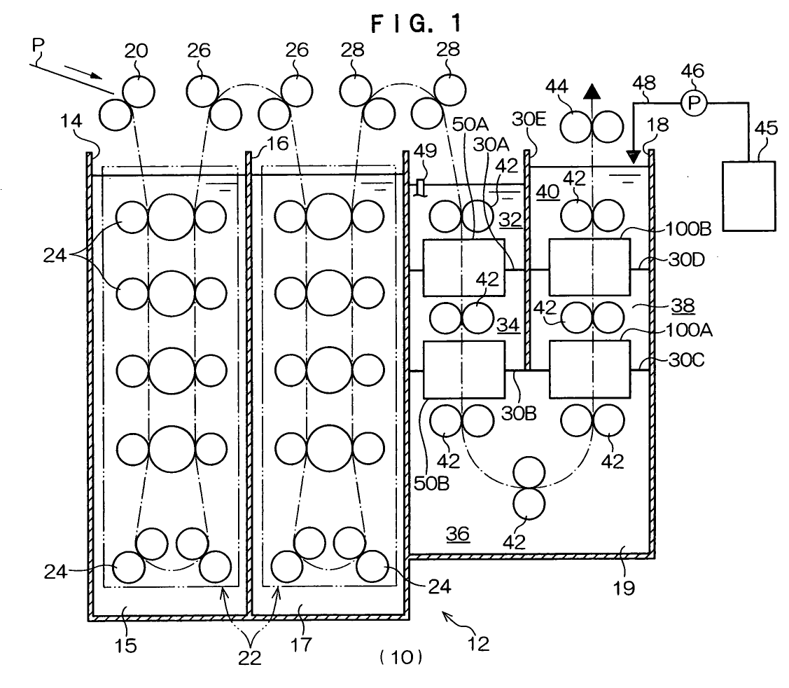

FIG. 1 shows a processing tank mainbody 12 installed in a photosensitive material processing apparatus 10 according to a first exemplary embodiment.

As shown in FIG. 1, the processing tank mainbody 12 includes a developing tank 14 storing a color developing liquid 15, a bleaching/fixing tank 16 storing a bleaching/fixing liquid 17, and a washing tank 18 storing washing water 19.

On the upstream of the developing tank 14 are provided guide rollers 20 which guide a photosensitive material (color paper) P that has been exposed to light by an exposing unit (not shown) in the photosensitive material processing apparatus 10, toward the developing tank 14.

Processing racks 22 are arranged in the developing tank 14 and the bleaching/fixing tank 16, and are respectively immersed in the color developing liquid 15 and the bleaching/fixing liquid 17. To the respective processing racks 22 are attached plural convey rollers 24. The photosensitive material P that has been guided to the developing tank 14 by the guide rollers 20, is conveyed by these convey rollers 24 so as to pass through the respective processing liquids in the developing tank 14 and the bleaching/fixing tank 16, and is thereby subject to development processing.

Moreover, between the developing tank 14 and the bleaching/fixing tank 16 are provided squeeze rollers 26. The photosensitive material P that has been pulled up from the developing tank 14 is conveyed by the squeeze rollers 26, so as to be guided to the bleaching/fixing tank 16. Furthermore, between the bleaching/fixing tank 16 and the washing tank 18 are provided squeeze rollers 28. The photosensitive material P that has been pulled up from the bleaching/fixing tank 16 is conveyed by the squeeze rollers 28, so as to be guided to the washing tank 18.

The interior of the washing tank 18 is sectioned by five partition walls 30A, 30B, 30C, 30D, and 30E into a first processing chamber 32, a second processing chamber 34, a third processing chamber 36, a fourth processing chamber 38, and a fifth processing chamber 40 sequentially from the upstream in the conveyance direction of the photosensitive material. The washing water 19 is stored respectively in these five processing chambers.

In this washing tank 18 is provided plural convey rollers 42 which convey the photosensitive material P that has been guided to the washing tank 18 by means of the squeeze rollers 28, in an approximate U-shape sequentially from the first processing chamber 32 to the fifth processing chamber 40 in the tank. The plurality of convey rollers 42 constitute a conveyance route of the photosensitive material P in the washing tank 18.

In the partition wall 30A arranged between the first processing chamber 32 and the second processing chamber 34, and the partition wall 30B arranged between the second processing chamber 34 and the third processing chamber 36 are respectively provided processing units with a squeezing function 50 (first processing unit 50A/second processing unit 50B) which allow the photosensitive material P to pass downward serving as the conveyance direction, but restrict the circulation of the washing water 19. In the partition wall 30C arranged between the third processing chamber 36 and the fourth processing chamber 38, and the partition wall 30D arranged between the fourth processing chamber 38 and the fifth processing chamber 40 are respectively provided processing units with a squeezing function 100 (third processing unit 100A/fourth processing unit 100B) which allow the photosensitive material P to pass upward serving as the conveyance direction, but restrict the circulation of the washing water 19. Moreover, as shown in FIG. 1, these processing units 50 and 100 are arranged in a vertical conveyance system on the conveyance route of the photosensitive material P constituted in an approximate U-shape in the washing tank 18.

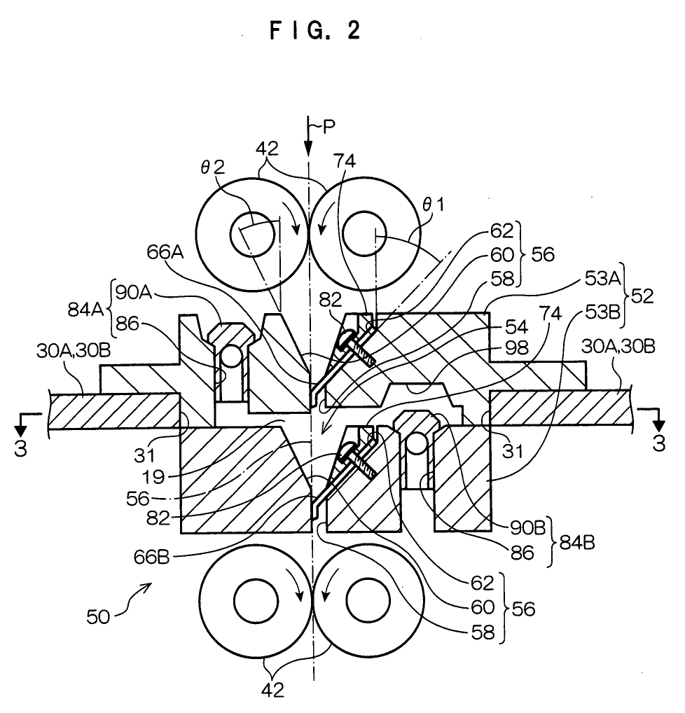

As shown in FIG. 2. the processing unit 50 includes a housing 52 inside of which is formed a processing space 54 storing the washing water 19. This housing 52 is fitted into an opening 31 formed in the partition walls 30A and 30B, and detachably attached thereto.

The housing 52 is constituted by a combination of a carry-in side housing member 53A arranged on the upstream side (carry-in side/upside) in the conveyance direction of the photosensitive material P, and a carry-out side housing member 53B arranged on the downstream side (carry-out side/downside) in the conveyance direction. The respective housing members are formed from a synthetic resin containing glass fibers such as PC, PPE, ABS, and PPS.

The carry-in side housing member 53A is formed with a conveyance path 56 which enables the photosensitive material P to pass downward along the vertical direction being the conveyance direction of the photosensitive material P by the convey rollers 42, in communication with a processing space 54.

The conveyance path 56 includes: a slit hole 58 of a fixed width which is formed long along the width direction of the photosensitive material P (orthogonal direction to the conveyance direction/depth direction of the sheet of FIG. 2); a guide surface portion 60 which is positioned on the upside of the respective inner faces in the longitudinal direction of the slit hole 58 (upstream side in the conveyance direction), and is opened so that the space becomes larger gradually from the respective inner faces toward the upside, so as to guide the photosensitive material P into the slit hole 58; and a blade attachment surface portion 62 which is to be attached with a blade 66A serving as a sealing device described later.

The blade attachment surface portion 62 is inclined to the conveyance direction of the photosensitive material P (vertical direction) by an angle θ1, and the guide surface portion 60 is inclined to the conveyance direction of the photosensitive material P by an angle θ2. These angle θ1 and angle θ2 are preferably within a range between 10° and 80°, and more preferably within a range between 10° and 30°.

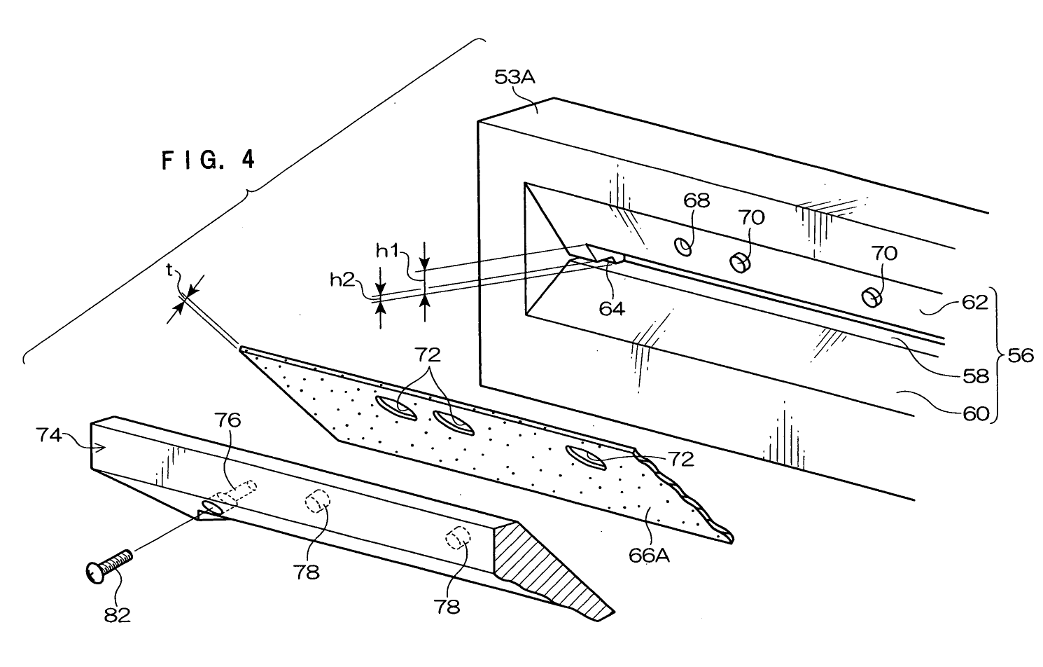

As shown in FIG. 4, in the vicinity of the opposite ends of the conveyance path 56 in the longitudinal direction (only one end is shown in FIG. 4) are formed grooves 64 from the intersection of the guide surface portion 60 and the blade attachment surface portion 62 toward the downstream side in the conveyance direction, along the slit hole 58. The width h2 of this groove 64 is made slightly larger than the thickness t of the blade 66A formed in a rectangular thin plate shape. For example it is set slightly thicker than the blade thickness by about 0.01 to 0.5 mm. The thickness t of the blade 66A is preferably about 0.3 to 0.7 mm, and is set to 0.5 mm in the present exemplary embodiment.

In this manner, by making the width h2 of the groove 64 slightly larger than the thickness t of the blade 66A, even in the case where the amount of thermal expansion (thermal expansion coefficient) of the blade 66A is greater than that of the carry-in side housing member 53A, the tip of the blade 66A whose dimension has been changed to larger due to thermal expansion can be inserted into the grooves 64 and relatively moved, preventing undulations and wrinkles of the blade 66A. The difference between the width h2 of the groove 64 and the thickness t of the blade 66A is preferably as small as possible, within a range allowing the blade 66A to be inserted into the grooves 64.

As shown in FIG. 4, in the blade attachment surface portion 62 are formed plural screw holes 68 and cylindrical projections 70 at predetermined positions along the longitudinal direction.

The blade 66A attached to the blade attachment surface portion 62 is formed from an elastic member in a thin sheet shape that is formed in a rectangle having a fixed thickness. This blade 66A is formed from for example a urethane resin, but may be formed from another elastic material such as a rubber. Preferred materials for the blade 66A are as follows.

A polyurethane resin having a JIS A hardness of 80 to 99 degree is suitable as the blade 66A used in the washing tank 18 where the photosensitive material P is washed with water. In particular, thermosetting polyurethane having a polyether prepolymer as a raw material is suitable as the material of the blade 66A used for a long time in a liquid.

TDI (trilene diisocyanate) and TDI prepolymers correspond to a polyisocyanate raw material. Regarding the polyether prepolymers, PTMG types (polytetramethylene ether glycol types) are particularly preferred. An aromatic amine compound is used as a curing agent.

Specific examples thereof include: Trade Name CORONATE 4080, CORONATE 4090, CORONATE 4095, CORONATE 4099, CORONATE 6912, and the like, manufactured by Nippon Polyurethane Industry Co., Ltd. These are TDI polyurethanes, and PTMG prepolymers can be used.

Alternatively, Trade Name TAKENATE L-2000 series, L-2690, L-2695, L-2705, L-2710, L2760 and the like manufactured by Takeda Chemical Industries, Ltd. may be used. These are PTMG polyurethane resins for casting.

Not being limited to the above materials, there may be applied a series of materials called aziprene type prepolymers (PTG(polyether polyols)/TDI type) among the prepolymer casting urethane elastomers on page 117 which are thermosetting urethane elastomers on page 116 of “Latest Applied Polyurethane Technology”, published by CMC, Feb. 26, 1983.

Moreover, the longitudinal dimension of the conveyance path 56 is made slightly larger than the longitudinal dimension of the blade 66A. For example it is set longer by about 0.1 to 1.5 mm.

In this manner, by making the longitudinal dimension of the conveyance path 56 slightly larger than the longitudinal dimension of the blade 66A, even in the case where the amount of thermal expansion (thermal expansion coefficient) of the blade 66A is greater than that of the carry-in side housing member 53A, the opposite ends in the longitudinal direction of the thermally expanded blade 66A do not come into a strong contact with the inner walls on the opposite sides in the longitudinal direction of the conveyance path 56, preventing strains (such as undulations and wrinkles) of the blade 66A.

In the blade 66A are formed elongated holes 72 along the longitudinal direction of the blade 66A, in respective positions corresponding to the screw holes 68 and the projections 70 formed in the blade attachment surface portion 62. Moreover, as shown in FIG. 4, this blade 66A is attached to the blade attachment surface portion 62 of the carry-in side housing member 53A, by means of a blade fixing member 74.

The blade fixing member 74 is formed from a synthetic resin which is the same material as that of the carry-in side housing member 53A, in a substantially triangular shape in cross-section and a long plate-like shape as seen in a plan view. The longitudinal dimension of the blade fixing member 74 is set to be the same as or slightly smaller than the longitudinal dimension of the blade 66A.

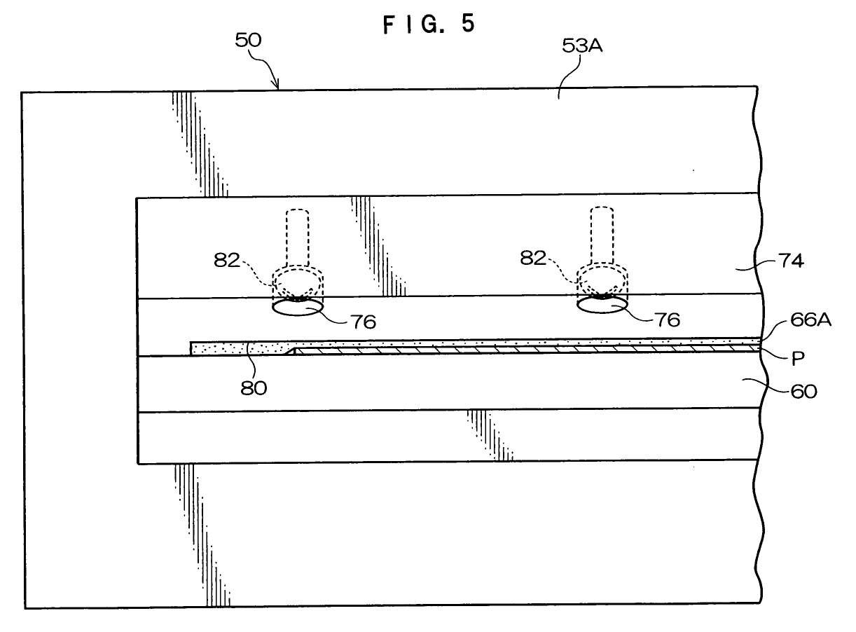

In the blade fixing member 74 are respectively formed through holes 76 in respective positions corresponding to the screw holes 68 in the blade attachment surface portion 62, and respectively formed fitting holes 78 in respective positions corresponding to the projections 70 thereon. Furthermore, as shown in FIG. 5, there is formed a notch 80 for forming a slit through which the photosensitive material P is passed.

In order to attach the blade 66A to the carry-in side housing member 53A by means of this blade fixing member 74, firstly, in the orientation shown in FIG. 4, the blade 66A is overlayed on the blade attachment surface portion 62 of the carry-in side housing member 53A. At this time, the blade 66A is positioned by fitting the respective elongated holes 72 onto the respectively corresponding projections 70 on the blade attachment surface portion 62. In this state, the respective screw holes 68 in the blade attachment surface portion 62 are matched with the positions of the respectively corresponding elongated holes 72 in the blade 66A

Next, in the orientation shown in FIG. 4, the blade fixing member 74 is overlayed on the blade 66A. At this time, the blade fixing member 74 is positioned by fitting the respective fitting holes 78 onto the respectively corresponding projections 70. In this state, the respective screw holes 68 and elongated holes 72 are matched with the positions of the respectively corresponding through holes 76 in the blade fixing member 74.

Finally, screws 82 are respectively inserted through the respective through holes 76 in the blade fixing member 74, so as to be fastened into the screw holes 68. Here, the blade 66A is fastened with a predetermined torque (fastening force) so as to be supported by a nipping force which allows the blade 66A to be relatively moved with respect to the carry-in side housing member 53A and the blade fixing member 74 at the time of thermal expansion.

As a result, the blade 66A is fixed so as to be nipped between the blade attachment surface portion 62 and the blade fixing member 74, in a state where the upside edge (base side) extending along the longitudinal direction and the vicinities of the edges at the opposite ends in the longitudinal direction are fitted tightly to the blade attachment surface portion 62. Moreover, the blade 66A is held in a state where the downside edge (tip side) extending all along the longitudinal length is elastically pressed against one inner wall face of the slit hole 58 so as to fit tightly thereto, and the opposite ends in the longitudinal direction are inserted in the grooves 64. By means of this blade 66A, in the slit hole 58 of the conveyance path 56 serving as the carry-in side, the photosensitive material P can pass in the conveyance direction, while between the first processing chamber 32 or the second processing chamber 34 and the processing space 54 is liquid-tightly sealed.

As shown in FIG. 2, in the carry-in side housing member 53A is provided a check valve 84A as a processing liquid changing device on the flow-out side, which is for circulating the washing water 19 in the opposite direction (upward) to the conveyance direction of the photosensitive material P so as to be flown out from the inside of the processing space 54.

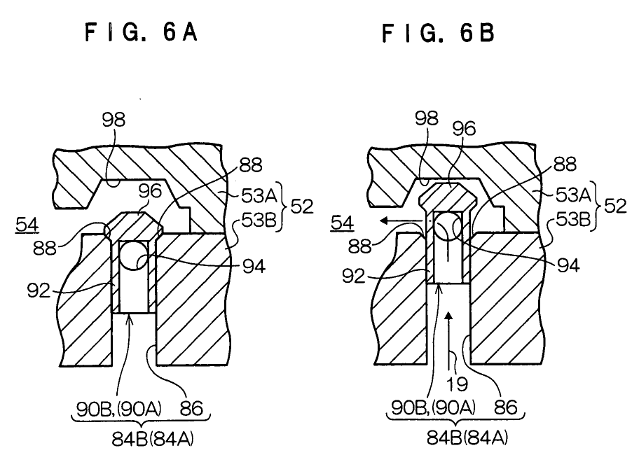

The check valve 84A is arranged in the vicinity of the end of the guide surface portion 60 side with respect to the conveyance path 56, and includes: a cross-sectionally circular valve hole 86 passing through in a straight line from the top face of the carry-in side housing member 53A to the bottom face constituting the ceiling of the processing space 54; and a valve body 90A which is inserted with play in the valve hole 86. As shown in FIG. 6A and FIG. 6B as a reference, the valve body 90A is designed such that an insertion portion 92 inserted into the valve hole 86 is cylindrical, and is formed with a cross-sectionally circular liquid circulation hole 94 passing through from the outer circumferential face of the insertion portion 92 to the inner circumferential face thereof, and a head portion is provided with an substantially conical valve portion 96 which is made one size larger than the insertion portion 92. On the other hand, on the top edge of the valve hole 86 which is in contact with the bottom edge of the valve portion 96, is formed a valve seat 88. The contact sites of these valve portion 96 and the valve seat 88 are made into tapered faces having the same angle of inclination so that, when the valve portion 96 is urged toward the valve seat 88 and is in contact therewith, a high sealing property is demonstrated due to the face engagement.

Moreover, in this check valve 84A which circulates the washing water 19 upward only, the setting is such that A/B becomes 1.0 or more but 1.5 or less assuming that the relative density of the valve body 90A is A and the relative density of the washing water 19 is B. In order to obtain this relationship for the relative density, the valve body 90A is formed from a synthetic resin such as polyamide (PA). The valve body 90A is not necessarily formed from the same material overall, and may be formed from plural materials. For example, in order to adjust the relative density, the mainbody may be made from a resin material having a relative density of less than 1.0, and the inside may be embedded or mixed with a member having a great relative density such as a metal or glass fiber.

In this check valve 84A constituted in this manner, in the case where there is no difference in liquid pressure between the first processing chamber 32 or the second processing chamber 34 and the processing space 54, such as a state where the washing water 19 is not filled in the fifth processing chamber 40 on the most downstream described later, then the valve body 90A sinks due to the force (gravity) caused by the difference in relative density to the washing water 19, and the valve portion 96 is fitted tightly onto the valve seat 88 to close the valve hole 86 (refer to FIG. 6A). As a result, the washing water 19 can be kept from flowing (backflowing) from the first processing chamber 32 or the second processing chamber 34 to the processing space 54.

Moreover, in the case where the liquid pressure of the processing space 54 becomes greater than that of the first processing chamber 32 or the second processing chamber 34, such as a state where the washing water 19 is filled in the fifth processing chamber 40, then the valve body 90A is pushed up into the washing water 19 in the processing space 54, and the valve portion 96 separates from the valve seat 88 to expose the liquid circulation hole 94 of the insertion portion 92 from the valve hole 86 (refer to FIG. 6B). As a result, the valve hole 86 is opened through the liquid circulation hole 94, and the washing water 19 in the processing space 54 passes through the valve hole 86 and the liquid circulation hole 94, and then flows out into the first processing chamber 32 or the second processing chamber 34.

Next is a description of the carry-out side housing member 53B which constitutes the housing 52 together with the abovementioned carry-in side housing member 53A.

As shown in FIG. 2, similarly to the carry-in side housing member 53A, the carry-out side housing member 53B is also formed with a conveyance path 56 which enables the photosensitive material P to pass downward along the vertical direction being the conveyance direction of the photosensitive material P, in communication with a processing space 54.

This conveyance path 56 has the same structure as that of the conveyance path 56 of the carry-in side housing member 53A side. That is, it includes: a slit hole 58, a guide surface portion 60, and a blade attachment surface portion 62. To the blade attachment surface portion 62 is attached a blade 66B having the same structure as that of the carry-in side housing member 53A side, by the blade fixing member 74 and the screws 82. By means of this blade 66B, in the slit hole 58 of the conveyance path 56 serving as the carry-out side, the photosensitive material P can pass in the conveyance direction, while between the second processing chamber 34 or the third processing chamber 36 and the processing space 54 is liquid-tightly sealed.

Moreover, as shown in FIG. 2, in the carry-out side housing member 53B is provided a check valve 84B as a processing liquid changing device on the flow-in side, which is for circulating the washing water 19 in the opposite direction (upward) to the conveyance direction of the photosensitive material P so as to be flown into the processing space 54.

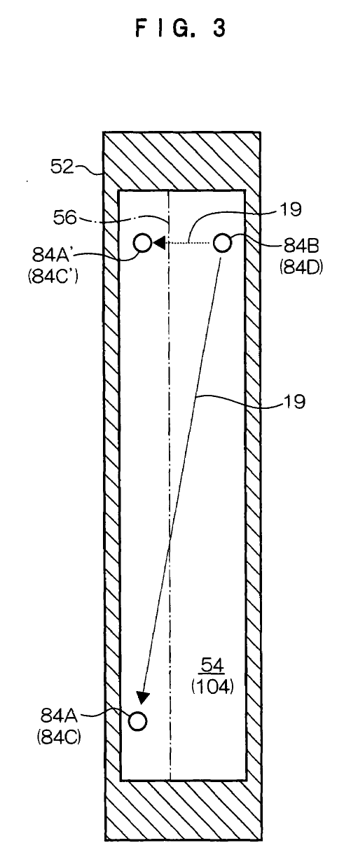

The check valve 84B is arranged in the vicinity of the end of the blade attachment surface portion 62 side with respect to the conveyance path 56, and therefore the check valve 84A of the flow-out side provided in the carry-in side housing member 53A and the check valve 84B of the flow-in side provided in the carry-out side housing member 53B are arranged on either side of the conveyance path 56. Furthermore, as shown in FIG. 3, the check valve 84A and the check valve 84B are arranged in substantially diagonal positions in the cross-sectional longitudinal direction of the conveyance path 56, so that the distance therebetween in the processing space 54 is as long as possible.

This check valve 84B has the same structure as that of the check valve 84A, and is opened/closed by the same principle. That is, it includes a valve hole 86 and a valve body 90B, and the setting is such that A/B becomes 1.0 or more but 1.5 or less assuming that the relative density of the valve body 90B is A and the relative density of the washing water 19 is B. In the case where there is no difference in liquid pressure between the processing space 54 and the second processing chamber 34 or the third processing chamber 36, the valve body 90B having a greater relative density than that of the washing water 19 sinks due to gravity to close the valve hole 86 (refer to FIG. 6A). As a result, the washing water 19 can be kept from backflowing from the processing space 54 to the second processing chamber 34 or the third processing chamber 36. Moreover, in the case where the liquid pressure of the second processing chamber 34 or the third processing chamber 36 becomes greater than that of the processing space 54, the valve body 90B is pushed up into the washing water 19 in the second processing chamber 34 or the third processing chamber 36, to open the valve hole 86 through the liquid circulation hole 94 (refer to FIG. 6B). As a result, the washing water 19 in the second processing chamber 34 or the third processing chamber 36 passes through the valve hole 86 and the liquid circulation hole 94 and then flows into the processing space 54.

Moreover, as shown in FIG. 6B, in the position corresponding to the valve body 90B in the bottom face of the carry-in side housing member 53A is formed a concavity 98 for enabling the raising operation (valve opening operation) of the valve body 90B.

Furthermore, as shown in FIG. 2, this carry-out side housing member 53B is fastened so as to be integrated with the carry-in side housing member 53A, in a state where the top face formed with the guide surface portion 60 and the blade attachment surface portion 62 is fitted tightly onto the bottom face formed with the slit hole 58 in the carry-in side housing member 53A, so as to constitute the housing 52.

In the housing 52 constituted in this manner, the processing space 54 formed inside thereof is constituted as a space enclosed by: the bottom face portion including the slit hole 58 and the concavity 98 of the carry-in side housing member 53A; the blade 66A and its blade fixing member 74; the upper face portion including the carry-in guide surface portion 60 and the blade attachment surface portion 62 of the carry-out side housing member 53B; and the blade 66B and its blade fixing member 74.

The structure of the processing unit 50 is as above. As described above, the housing 52 is attached to the partition walls 30A and 30B, and thereby arranged between the first processing chamber 32 and the second processing chamber 34, and between the second processing chamber 34 and the third processing chamber 36.

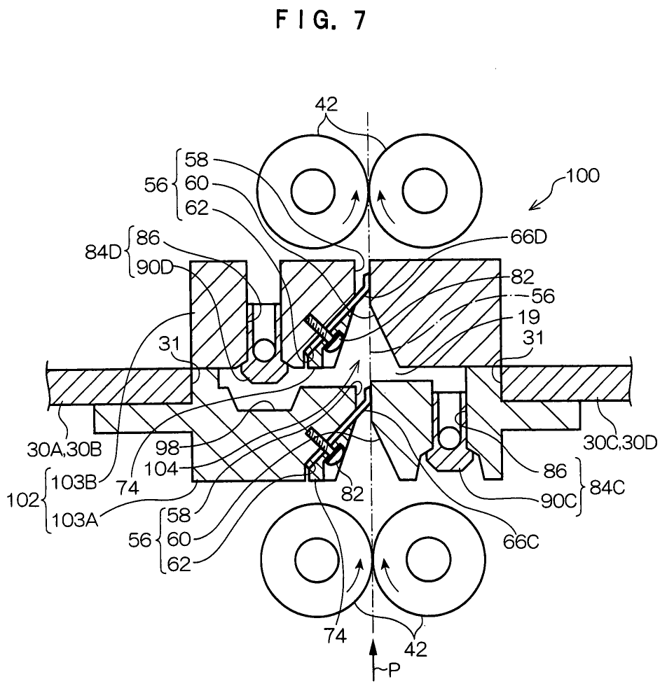

On the other hand, as shown in FIG. 7, the processing unit 100 has a structure which is basically up side down of the processing unit 50, and includes a housing 102 the inside of which is formed with a processing space 104 storing the washing water 19. This housing 102 is fitted into an opening 31 formed in the partition walls 30C and 30D, and detachably attached thereto.

The housing 102 is constituted by a combination of a carry-in side housing member 103A arranged on the upstream side (carry-in side/downside) in the conveyance direction of the photosensitive material P, and a carry-out side housing member 103B arranged on the downstream side (carry-out side/upside) in the conveyance direction. The respective housing members are formed from a synthetic resin which is the same material as that of the housing members of the processing unit 50.

The carry-in side housing member 103A and the carry-out side housing member 103B are respectively formed with a conveyance path 56 which enables the photosensitive material P to pass upward along the vertical direction being the conveyance direction of the photosensitive material P by the convey rollers 42, in communication with a processing space 104.

This conveyance path 56 has the same structure as that of the conveyance path 56 of the processing unit 50. That is, it includes: a slit hole 58, a guide surface portion 60, and a blade attachment surface portion 62. To the blade attachment surface portion 62 is attached blades 66C and 66D having the same structure as that of the processing unit 50, by the blade fixing member 74 and the screws 82. By means of these blades 66C and 66D, in the slit holes 58 of the respective conveyance paths 56 of the carry-in side housing member 103A and the carry-out side housing member 103B, the photosensitive material P can pass in the conveyance direction, while between the third processing chamber 36 to the fifth processing chamber 40 and the processing space 104 is liquid-tightly sealed.

Moreover, as shown in FIG. 7, in the carry-in side housing member 103A is provided a check valve 84C as a processing liquid changing device on the flow-out side, which is for circulating the washing water 19 in the opposite direction (downward) to the conveyance direction of the photosensitive material P so as to be flown out from the processing space 104. In the carry-out side housing member 103B is provided a check valve 84D as a processing liquid changing device on the flow-in side, which is for circulating the washing water 19 in the opposite direction (downward) to the conveyance direction of the photosensitive material P so as to be flown into the processing space 104.

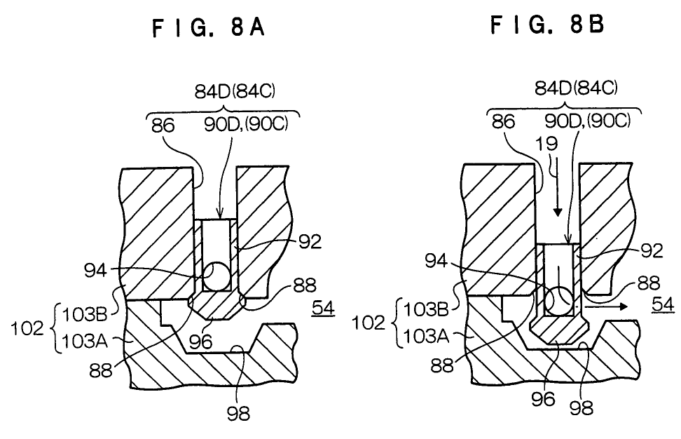

Similarly to the check valves 84A and 84B of the processing unit 50, these check valves 84C and 84D comprise valve holes 86 and valve bodies 90C and 90D (refer to FIG. 8A and FIG. 8B). However, regarding the valve bodies 90C and 90D, the setting is such that A/B becomes 0.6 or more but 1.0 or less assuming that the relative density thereof is A and the relative density of the washing water 19 is B.

In order to obtain this relationship for the relative density, the valve bodies 90C and 90D are formed from a synthetic resin such as polypropylene (PP) and polyethylene (PE). Moreover, in order to adjust the relative density, the inside of the valve body such as a head portion may be provided with a hollow portion so as to give a buoyant force.

Furthermore, similarly to the check valves 84A and 84B of the processing unit 50, the check valves 84C and 84D provided in this processing unit 100 are arranged on either side of the conveyance path 56, in substantially diagonal positions in the cross-sectional longitudinal direction of the conveyance path 56, so that the distance therebetween in the processing space 104 is as long as possible (refer to FIG. 3).

In the position corresponding to the valve body 90D in the top face of the carry-in side housing member 103A is formed a concavity 98 for enabling the lowering operation (valve opening operation) of the valve body 90D.

These check valves 84C and 84D are opened/closed by the opposite principle to that of the check valves 84A and 84B. That is, in the check valve 84C, in the case where there is no difference in liquid pressure between the processing space 54 and the third processing chamber 36 or the fourth processing chamber 38, the valve body 90C floats due to the force (buoyant force) caused by the difference in relative density to the washing water 19, and the valve portion 96 is fitted tightly onto the valve seat 88 to close the valve hole 86 (refer to FIG. 8A). As a result, the washing water 19 can be kept from flowing (backflowing) from the third processing chamber 36 or the fourth processing chamber 38 to the processing space 104. Moreover, in the case where the liquid pressure of the processing space 104 becomes greater than that of the third processing chamber 36 or the fourth processing chamber 38, the valve body 90C is pushed down into the washing water 19 in the processing space 104, and the valve portion 96 separates from the valve seat 88 to expose the liquid circulation hole 94 of the insertion portion 92 from the valve hole 86 (refer to FIG. 8B). As a result, the valve hole 86 is opened through the liquid circulation hole 94, and the washing water 19 in the processing space 104 passes through the valve hole 86 and the liquid circulation hole 94 and then flows out into the third processing chamber 36 or the fourth processing chamber 38.

On the other hand, in the check valve 84D, in the case where there is no difference in liquid pressure between the processing space 104 and the fourth processing chamber 38 or the fifth processing chamber 40, the valve body 90D floats due to the buoyant force with respect to the washing water 19, to close the valve hole 86 (refer to FIG. 8A). As a result, the washing water 19 can be kept from backflowing from the processing space 104 to the fourth processing chamber 38 or the fifth processing chamber 40. Moreover, in the case where the liquid pressure of the fourth processing chamber 38 or the fifth processing chamber 40 becomes greater than that of the processing space 104, the valve body 90D is pushed down into the washing water 19 in the fourth processing chamber 38 or the fifth processing chamber 40, to open the valve hole 86 through the liquid circulation hole 94 (refer to FIG. 8B). As a result, the washing water 19 in the fourth processing chamber 38 or the fifth processing chamber 40 passes through the valve hole 86 and the liquid circulation hole 94 and then flows into the processing space 104.

Furthermore, as shown in FIG. 7, these carry-in side housing member 103A and carry-out side housing member 103B are fastened so as to be integrated with each other, in a state where the bottom face formed with the guide surface portion 60 and the blade attachment surface portion 62 of the carry-out side housing member 103B is fitted tightly onto the top face formed with the slit hole 58 in the carry-in side housing member 103A, so as to constitute the housing 102.

In the housing 102 constituted in this manner, the processing space 104 formed inside thereof is constituted as a space enclosed by: the top face portion including the slit hole 58 and the concavity 98 of the carry-in side housing member 103A; the blade 66C and its blade fixing member 74; the bottom face portion including the carry-in guide surface portion 60 and the blade attachment surface portion 62 of the carry-out side housing member 103B; and the blade 66D and its blade fixing member 74.

The structure of the processing unit 100 is as above. As described above, the housing 102 is attached to the partition walls 30C and 30D, and thereby arranged between the third processing chamber 36 and the fourth processing chamber 38, and between the fourth processing chamber 38 and the fifth processing chamber 40.

Moreover, in the washing tank 18, the photosensitive material P that has been conveyed from the bleaching/fixing tank 16 is conveyed on the conveyance route (conveyance path 56) in the order of the first processing chambers 32, the first processing unit 50A, the second processing chamber 34, the second processing unit SOB, the third processing chamber 36, the third processing unit 10A, the fourth processing chamber 38, the fourth processing unit 100B, and the fifth processing chamber 40, by means of the convey rollers 42, passing through the washing water in the respective processing chambers and the respective processing units, and is thereby washed by water. Then, the photosensitive material P is pulled up from the fifth processing chamber 40 by discharge rollers 44, and then conveyed to a drying section (not shown).

Moreover, the photosensitive material processing apparatus 10 includes a washing water replenish tank 45 which stores the washing water 19 for replenishment. Between the washing water replenish tank 45 and the fifth processing chamber 40 is arranged a feed water pipe 48 connected with a pump 46 partway therealong. By driving this pump 46, a predetermined amount of the washing water 19 according to the evaporation amount thereof and the processing amount of the photosensitive material P, is replenished from the washing water replenish tank 45 through the feed water pipe 48 into the fifth processing chamber 40 of the washing tank 18. Then, this replenished fresh washing water 19 flows from the fifth processing chamber 40 through the respective processing units and the respective processing chambers to the first processing chamber 32 side, in the opposite direction to the conveyance direction of the photosensitive material P.

In the first processing chamber 32 is provided an overflow pipe 49 for discharging the washing water 19. When the height of the liquid surface of this first processing chamber 32 reaches the inflow port of the overflow pipe 49, the washing water 19 polluted by the washing of the photosensitive material P overflows to the overflow pipe 49, and is discharged into a storage tank (not shown) or the like. As a result, the height of the liquid surface of the washing water 19 stored in the first processing chamber 32 is controlled to be kept within a predetermined range.

Next is a description of the action of the photosensitive material processing apparatus 10 according to the present exemplary embodiment.

In the photosensitive material processing apparatus 10, the exposed photosensitive material P passes through sequentially from the developing tank 14, the bleaching/fixing tank 16, and the washing tank 18 of the processing tank mainbody 12, and thereby respective processings of color developing, bleaching/fixing, and washing with water are performed. The washed photosensitive material P is dried by the drying section, and released to become a printed photograph.

In this processing course, while the photosensitive material P that has been carried into the washing tank 18 is conveyed by the convey rollers 42, it is firstly soaked into the washing water 19 stored in the first processing chamber 32 to be washed, and then is conveyed to the first processing unit 50A downward.

In the first processing unit 50A, while the photosensitive material P is being guided by the guide surface portion 60 provided on the carry-in side housing member 53A and is elastically deforming the blade 66A, it is slid between the slit hole 58 and the blade 66A, and is squeezed so as to keep the washing water 19 in the first processing chambers 32 from flowing into the processing space 54 side, then passes through the conveyance path 56, and enters the inside of the processing space 54. In this processing space 54, a part of the photosensitive material P entering the space is washed with the washing water 19 stored in the space.

Furthermore, while the photosensitive material P to be conveyed downward is guided by the guide surface portion 60 provided on the carry-out side housing member 53B and is elastically deforming the blade 66B, it is slid between the slit hole 58 and the blade 66B, and is squeezed so as to keep the washing water 19 in the processing space 54 from flowing into the second processing chamber 34 side, then passes through the conveyance path 56, and is carried into the second processing chamber 34.

In the same way, the photosensitive material P is repeatedly and alternately washed in the second processing chamber 34 to the fifth processing chamber 40, squeezed in the second processing unit 50B to the fourth processing unit 100B, and washed in the processing spaces 54 and 104, and is finally carried out from the washing tank 18.

In this manner, when the photosensitive material P passes through the processing units with a squeezing function 50 and 100, it is washed with the washing water 19 in the processing spaces 54 and 104, and thereby the washing efficiency of the photosensitive material P is improved.

Moreover, in this photosensitive material processing apparatus 10, by driving the pump 46, a predetermined amount of the washing water 19 according to the evaporation amount of the washing water 19 in the washing tank 18 and the processing amount of the photosensitive material P, is replenished from the washing water replenish tank 45 through the feed water pipe 48 into the fifth processing chamber 40. This replenished fresh washing water 19 flows from the fifth processing chamber 40 through the respective processing units and the respective processing chambers to the first processing chamber 32 side, in the opposite direction to the conveyance direction of the photosensitive material P. In this course, the washing water 19 is made to contact with the photosensitive material P conveyed in the washing tank 18 to wash it. The polluted washing water 19 overflows to the overflow pipe 49 in the first processing chamber 32, and is discharged.

Here, in the processing spaces 54 and 104 of the processing units 50 and 100, conditions of the stored washing water 19 (concentration and degree of pollution) are kept substantially constant between the carry-in side and the carry-out side of the photosensitive material P on the conveyance path 56; by the arrangement where: the pair of blades 66 liquid-tightly seal between the respective adjacent processing chambers while enabling photosensitive material P to pass therethrough; and furthermore the washing water 19 is exchanged by the check valves 84B and 84D of the flow-in side provided in the housing 52 and 102 which enable the washing water 19 to flow-in from the respective processing chambers, and by the check valves 84A and 84C of the flow-out side which enable the washing water 19 to flow-out to the respective processing chambers. As a result, the photosensitive material P passed and conveyed through the processing spaces 54 and 104 can be quickly and stably processed. By using such a double blade submerged processing method, the conveyance route can be shortened, thereby miniaturizing the apparatus and reducing the cost.

Moreover, in the processing units 50 and 100 of the present exemplary embodiment, the check valves 84A and 84C of the flow-out side provided in the carry-in side housing members 53A and 103A, and the check valves 84B and 84D of the flow-in side provided in the carry-out side housing members 53B and 103B are arranged on either side of the conveyance path 56 in substantially diagonal positions in the cross-sectional longitudinal direction of the conveyance path 56. Therefore, as shown in FIG. 3, the washing water 19 that has flown into the processing spaces 54 and 104 by opening the check valves 84B and 84D, passes from one corner side of the longitudinal direction of the conveyance path 56, crosses over the conveyance path 56, flows to the other corner side on an approximate diagonal, and flows out by opening the check valves 84A and 84C. As a result, all the washing water 19 in the processing spaces 54 and 104 can be efficiently exchanged, and agitating and replacement thereof are accelerated by a vortex caused by the photosensitive material P conveyed on the conveyance path 56 and passing through the processing spaces 54 and 104 crossing over in the liquid circulation area. As a result, for example, even in a state where the washing water 19 in the washing tank 18 has a concentration gradient from the upstream to the downstream including the processing spaces 54 and 104, the washing water 19 on the upstream side that has flown into the processing spaces 54 and 104 can be prevented from flowing to the downstream side with the same concentration. In this manner, by sufficiently agitating and replacing the washing water 19 in the processing spaces 54 and 104, the processing efficiency can be further improved and the treatment performance can be further stabilized.

Moreover, the check valves 84B and 84D of the flow-in side and the check valves 84A and 84C of the flow-out side are arranged in substantially diagonal positions in the cross-sectional longitudinal direction of the conveyance path 56, and thereby the flow distance of the washing water 19 flowing and crossing over the conveyance path 56 in the processing spaces 54 and 104 is elongated. As a result, the washing water 19 can be quickly and sufficiently agitated in the whole chamber, improving the agitating effect. Regarding the arrangement of the check valves of the flow-in side and the flow-out side, besides the substantially diagonal positions in the cross-sectional longitudinal direction of the conveyance path 56 as described above, for example, they may be substantially opposed on either side of the conveyance path 56 as with the check valves 84A′ and 84C′ shown in FIG. 3. However, the agitating effect in the whole processing space can be more improved in the abovementioned diagonal arrangement, rather than in such an opposed arrangement.

Similarly to the present exemplary embodiment, in a conveyance system where the photosensitive material P is vertically conveyed, by making the circulation direction of the processing liquid at the check valves 84A to 84D parallel (vertical) to the conveyance direction of the photosensitive material P, the washing water 19 can be smoothly circulated (exchanged) by the check valves 84A to 84D, and such an application to the vertical conveyance system becomes possible.

A processing liquid changing device which smoothly circulates the washing water 19 from the upstream side to the downstream side to exchange it, while reliably preventing the washing water 19 from flowing (backflowing) from the downstream side to the upstream side, can be realized by the check valves 84A to 84D readily at a low cost.

In the check valves 84A to 84D of the present exemplary embodiment, the valve bodies 90A to 90D are urged onto the valve seat 88 of the valve hole 86 formed in the housing to be closed, by a force generated due to the difference in relative density to the washing water 19, and when the liquid pressure is different between adjacent processing chamber/processing space on the upstream side/downstream side, the valve bodies 90A to 90D separate from the valve seat 88 due to the difference in liquid pressure, to be opened. In this manner, by opening/closing using the difference in relative density to the washing water 19 and the difference in liquid pressure between the upstream side/downstream side, it becomes unnecessary to separately provide a driving device or the like for opening/closing, and the structure can be further simplified.

In the present exemplary embodiment, in the structure where the washing water 19 is circulated upward through the check valve 84 (check valves 84A and 84B), since the relative density of valve body:A/relative density of processing liquid:B is set to 1.0 or more but 1.5 or less, the valve body 90 is pushed down by gravity to be closed. Moreover, the check valve 84 is pushed up by the liquid pressure applied from the downstream side to be opened. Therefore, the check valve 84 can be smoothly opened and closed.

In the structure where the washing water 19 is circulated downward through the check valve 84 (check valves 84C and 84D), since the relative density of valve body:A/relative density of processing liquid:B is set to 0.6 or more but 1.0 or less, the valve body 90 is pushed up by the buoyant force to be closed. Moreover, the check valve 84 is pushed down by the liquid pressure applied from the downstream side to be opened. Therefore, the check valve 84 can be smoothly opened and closed.

### Second Exemplary Embodiment

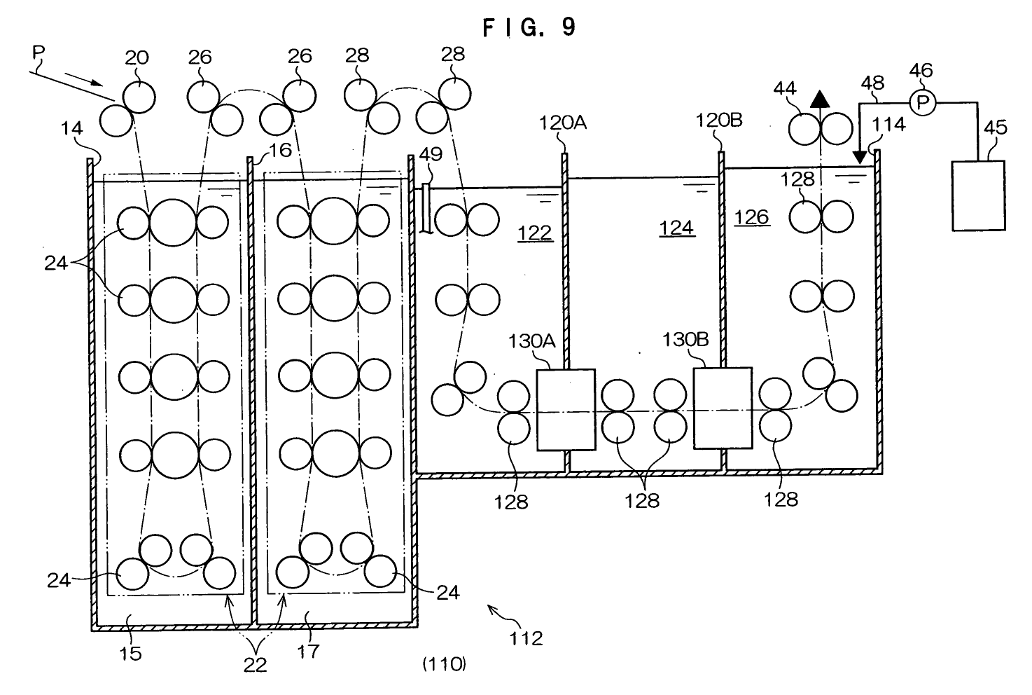

FIG. 9 shows a processing tank mainbody 112 installed in a photosensitive material processing apparatus 110 according to a second exemplary embodiment.

As shown in FIG. 9, the processing tank mainbody 112 includes a developing tank 14 and a bleaching/fixing tank 16 having the same structure of those of the first exemplary embodiment, and a washing tank 114 of the second exemplary embodiment storing washing water 19.

Inside of the washing tank 114 is sectioned by two partition walls 120A and 120B into a first processing chamber 122, a second processing chamber 124, and a third processing chamber 126 sequentially from the upstream in the conveyance direction of the photosensitive material. The washing water 19 is stored respectively in these three processing chambers.

In this washing tank 114 is provided plural convey rollers 128 which convey the photosensitive material P that has been guided to the washing tank 114 by means of the squeeze rollers 28, in an approximate U-shape sequentially from the first processing chamber 122, the second processing chamber 124, and the third processing chamber 126 in the tank. The plural convey rollers 128 constitute a conveyance route of the photosensitive material P in the washing tank 114.

In the two partition walls 120A and 120B are respectively provided processing units with a squeezing function 130 (first processing unit 130A/second processing unit 130B) which allow the photosensitive material P to pass in the horizontal direction (right direction of FIG. 9) being the conveyance direction of the photosensitive material P, but restrict the circulation of the washing water 19. Moreover, as shown in FIG. 9, the respective processing units 130 are arranged in a horizontal conveyance system on the conveyance route of the photosensitive material P constituted in an approximate U-shape in the washing tank 114.

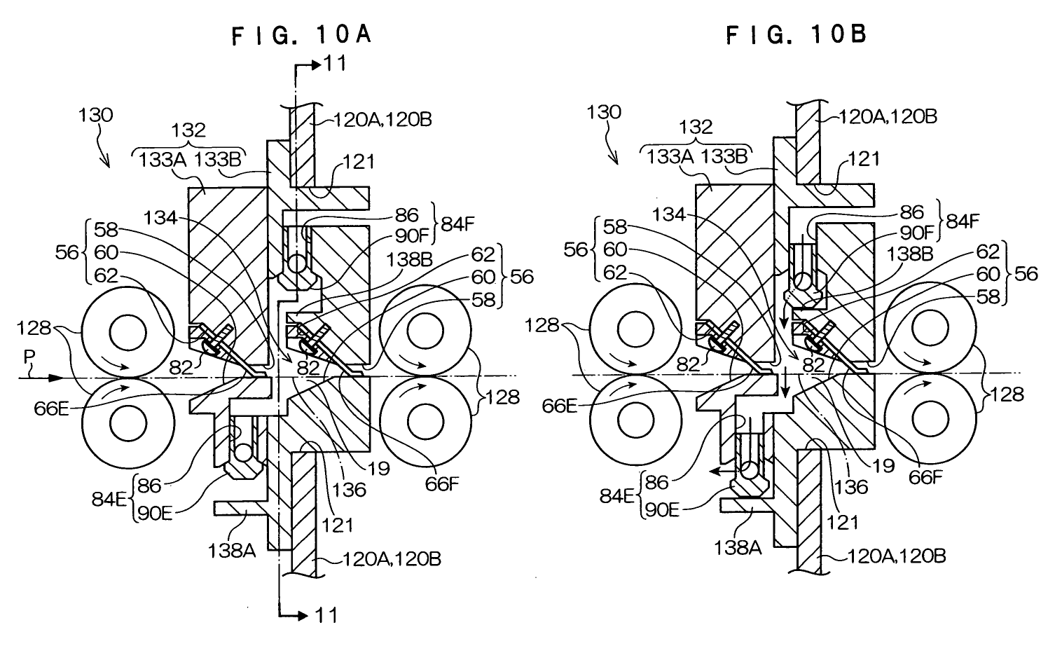

As shown in FIG. 10A and FIG. 10B, the processing unit 130 includes a housing 132 inside of which is formed a processing space 134 storing the washing water 19. This housing 132 is fitted into an opening 121 formed in the partition walls 120A and 120B, and detachably attached thereto.

The housing 132 is constituted by a combination of a carry-in side housing member 133A arranged on the upstream side (carry-in side/left side) in the conveyance direction of the photosensitive material P, and a carry-out side housing member 133B arranged on the downstream side (carry-out side/right side) in the conveyance direction. The respective housing members are formed from a synthetic resin which is the same material as that of the housing members of the processing units 50 and 100 of the first exemplary embodiment.

The carry-in side housing member 133A and carry-out side housing member 133B are respectively formed with a conveyance path 136 which enables the photosensitive material P to pass to the right along the horizontal direction being the conveyance direction of the photosensitive material P by the convey rollers 128, in communication with a processing space 134.

This conveyance path 136 has the same structure as that of the conveyance path 56 provided in the processing units 50 and 100 of the first exemplary embodiment. That is, it includes: a slit hole 58, a guide surface portion 60, and a blade attachment surface portion 62. To the blade attachment surface portion 62 are attached blades 66E and 66F having the same structure as that of the first exemplary embodiment, by the blade fixing member 74 and the screws 82. By these blades 66E and 66F, in the slit hole 58 of the respective conveyance paths 136 of the carry-in side housing member 133A and the carry-out side housing member 133B, the photosensitive material P can pass in the conveyance direction, while between the first processing chamber 122 to the third processing chamber 126 and the processing space 134 is liquid-tightly sealed.

Moreover, in the carry-in side housing member 133A is provided a check valve 84E as a processing liquid changing device on the flow-out side, which is for circulating the washing water 19 in the orthogonal direction (downward) to the conveyance direction of the photosensitive material P so as to be flown out from the processing space 134. In the carry-out side housing member 133B is provided a check valve 84F as a processing liquid changing device on the flow-in side, which is for circulating the washing water 19 in the orthogonal direction (downward) to the conveyance direction of the photosensitive material P so as to be flown into the processing space 134.

Similarly to the check valves 84A and 84B of the processing units 50 and 100 of the first exemplary embodiment, these check valves 84E and 84F comprise valve holes 86 and valve bodies 90E and 90F. Moreover, in the same way as those of the valve bodies 90C and 90D of the first exemplary embodiment, regarding the valve bodies 90E and 90F, the setting is such that A/B becomes 0.6 or more but 1.0 or less assuming that the relative density thereof is A and the relative density of the washing water 19 is B.

Moreover, in the position in the carry-out side housing member 133B corresponding to the valve body 90E, is formed a stopper portion 138A which enables the lowering operation (valve opening operation) of the valve body 90E while restricting the operation range. In the position corresponding to the valve body 90F is formed a stopper portion 138B which enables the lowering operation (valve opening operation) of the valve body 90F while restricting the operation range.

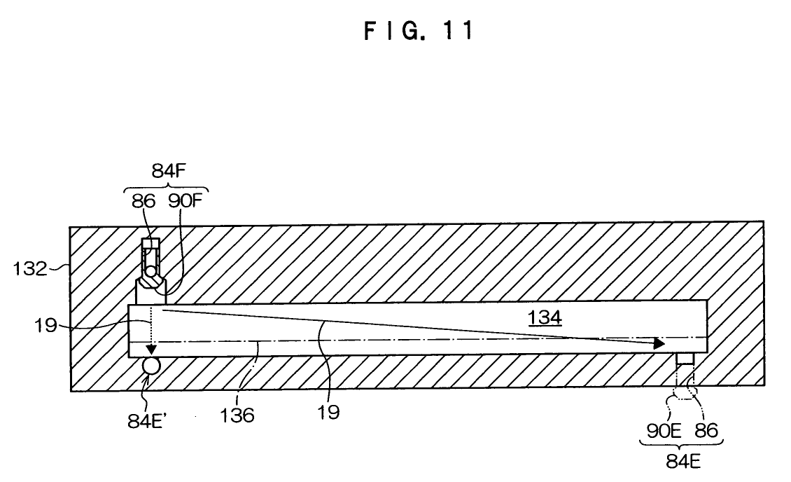

Furthermore, in the processing unit 130 of the present exemplary embodiment, the check valves 84E and 84F are arranged on either side of the conveyance path 136. As shown in FIG. 11, they are arranged in substantially diagonal positions in the cross-sectional longitudinal direction of the conveyance path 136, so that the distance therebetween in the processing space 134 is as long as possible. The check valve 84E of the flow-out side is arranged downward with respect to the check valve 84F of the flow-in side on either side of the conveyance path 136.

These check valves 84E and 84F are opened/closed by the same principle as for the check valves 84C and 84D provided in the processing unit 100 of the first exemplary embodiment. That is, in the check valve 84E, in the case where there is no difference in liquid pressure between the processing space 134 and the first processing chamber 122 or the second processing chamber 124, the valve body 90E floats due to the buoyant force with respect to the washing water 19, to close the valve hole 86 (refer to FIG. 10A). As a result, the washing water 19 can be kept from backflowing from the first processing chamber 122 or the second processing chamber 124 to the processing space 134. Moreover, in the case where the liquid pressure of the processing space 134 becomes greater than that of the first processing chamber 122 or the second processing chamber 124, the valve body 90E is pushed down into the washing water 19 in the processing space 134, to open the valve hole 86 through the liquid circulation hole 94 (refer to FIG. 10B). As a result, the valve hole 86 is opened through the liquid circulation hole 94, and the washing water 19 in the processing space 134 passes through the valve hole 86 and the liquid circulation hole 94 and then flows out to the first processing chamber 122 or the second processing chamber 124.

On the other hand, in the check valve 84F, in the case where there is no difference in liquid pressure between the processing space 134 and the second processing chamber 124 or the third processing chamber 126, the valve body 90F floats due to the buoyant force with respect to the washing water 19 to close the valve hole 86 (refer to FIG. 10A). As a result, the washing water 19 can be kept from backflowing from the processing space 134 to the second processing chamber 124 or the third processing chamber 126. Moreover, in the case where the liquid pressure of the second processing chamber 124 or the third processing chamber 126 becomes greater than that of the processing space 134, the valve body 90F is pushed down into the washing water 19 in the second processing chamber 124 or the third processing chamber 126, to open the valve hole 86 through the liquid circulation hole 94 (refer to FIG. 10B). As a result, the washing water 19 in the second processing chamber 124 or the third processing chamber 126 passes through the valve hole 86 and the liquid circulation hole 94 and then flows into the processing space 134.

By the same structure as that of the first exemplary embodiment, in the washing tank 114 of the present exemplary embodiment, fresh washing water 19 is replenished from the feed water pipe 48 into the third processing chamber 126. The washing water 19 polluted by the washing of the photosensitive material P is discharged from the overflow pipe 49 in the first processing chamber 122. In this washing tank 114, the setting is such that the pump head of the third processing chamber 126 at the end into which the washing water 19 is directly replenished, is the highest, and the pump head becomes gradually lower from the third processing chamber 126 to the first processing chamber 122.

By the above structure, in the photosensitive material processing apparatus 110 of the present exemplary embodiment, the exposed photosensitive material P passes through sequentially from the developing tank 14, the bleaching/fixing tank 16, and the washing tank 114 of the processing tank mainbody 112, and thereby respective processings of color developing, bleaching/fixing, and washing with water are performed.

In this processing course, while the photosensitive material P that has been carried into the washing tank 114 is conveyed by the convey rollers 128, it is repeatedly and alternately washed in the first processing chamber 122 to the third processing chamber 126, squeezed in the first and second processing units 130A and 130B, and washed in the processing space 134, and then is carried out from the washing tank 114. Therefore, in the photosensitive material processing apparatus 110 of the present exemplary embodiment, when the photosensitive material P passes through the processing unit with a squeezing function 130, it is washed with the washing water 19 in the processing space 134, and thereby the washing efficiency of the photosensitive material P is improved.

Moreover, the processing unit 130 of the present exemplary embodiment uses the double blade submerged processing method, and this double blade processing space has a treatment performance corresponding to about 0.5 tanks of a washing tank. In the washing tank 114 of the present exemplary embodiment applying this double blade processing space into a horizontal conveyance system (horizontal washing system), although a four-tank washing structure has been conventionally required, an equivalent treatment performance can be achieved with three tanks (three processing chambers). By omitting this amount of one tank, the apparatus can be miniaturized. Furthermore, the cost can be reduced by the omission of convey rollers, processing racks, and replenish/circulation parts for the amount of one tank.

Moreover, in this photosensitive material processing apparatus 110, after the washing water 19 is replenished into the third processing chamber 126 in the washing tank 114, the replenished fresh washing water 19 flows from the fifth processing chamber 40 to the first processing chamber 122 side, in the opposite direction to the conveyance direction of the photosensitive material P. In this course, the photosensitive material P conveyed in the washing tank 114 is washed. The polluted washing water 19 is discharged from the overflow pipe 49 in the first processing chamber 122.

Here, similarly to the first exemplary embodiment, in the processing unit 130 of the present exemplary embodiment, the check valve 84E of the flow-out side provided in the carry-in side housing member 133A, and the check valve 84F of the flow-in side provided in the carry-out side housing member 133B are arranged on either side of the conveyance path 136 in substantially diagonal positions in the cross-sectional longitudinal direction of the conveyance path 136. Therefore, as shown in FIG. 11, the washing water 19 that has flown into the processing space 134 by opening the check valve 84F, passes from one corner side of the longitudinal direction of the conveyance path 136, crosses over the conveyance path 136, flows to the other corner side on an approximate diagonal, and flows out by opening the check valve 84E. As a result, all the washing water 19 in the processing space 134 can be efficiently exchanged, and agitating and replacement thereof are accelerated by a vortex caused by the photosensitive material P conveyed on the conveyance path 136 and passing through the processing space 134 crossing over in the liquid circulation area. Therefore, the processing efficiency can be further improved and the treatment performance can be further stabilized.

Moreover, also in the case of the present exemplary embodiment, the check valve 84F of the flow-in side and the check valve 84E of the flow-out side are arranged in substantially diagonal positions in the cross-sectional longitudinal direction of the conveyance path 136, and thereby the flow distance of the washing water 19 flowing and crossing over the conveyance path 136 in the processing space 134 is elongated. As a result, the washing water 19 can be quickly and sufficiently agitated in the whole chamber, improving the agitating effect.

Furthermore, also in this processing unit 130 applied to the horizontal conveyance system, the check valves of the flow-in side and the flow-out side may be substantially opposed on either side of the conveyance path 136 as with the check valve 84E′ shown in FIG. 11. However, also in this case, the agitating effect in the whole processing space can be more improved in the diagonal arrangement, rather than in the opposed arrangement.

Likewise the present exemplary embodiment, in a structure where: the conveyance direction of the photosensitive material P is horizontal; the liquid circulation direction by means of the check valves 84E and 84F is vertical; and the washing water 19 flows downward through the check valves 84E and 84F, by arranging the check valve 84E (valve body 90E) of the flow-out side downward with respect to the check valve 84F (valve body 90F) of the flow-in side on either side of the conveyance path 136, then, for example when the washing water 19 in the washing tank 114 is to be taken out for maintenance or the like, the valve bodies 90E and 90F of the flow-in and flow-out sides lose the buoyant force and come into the open state, and thereby the washing water 19 flows from the flow-in side positioned upward to the flow-out side positioned downward. As a result, liquid in the processing space 134 can be readily and satisfactorily taken out.

### Third Exemplary Embodiment

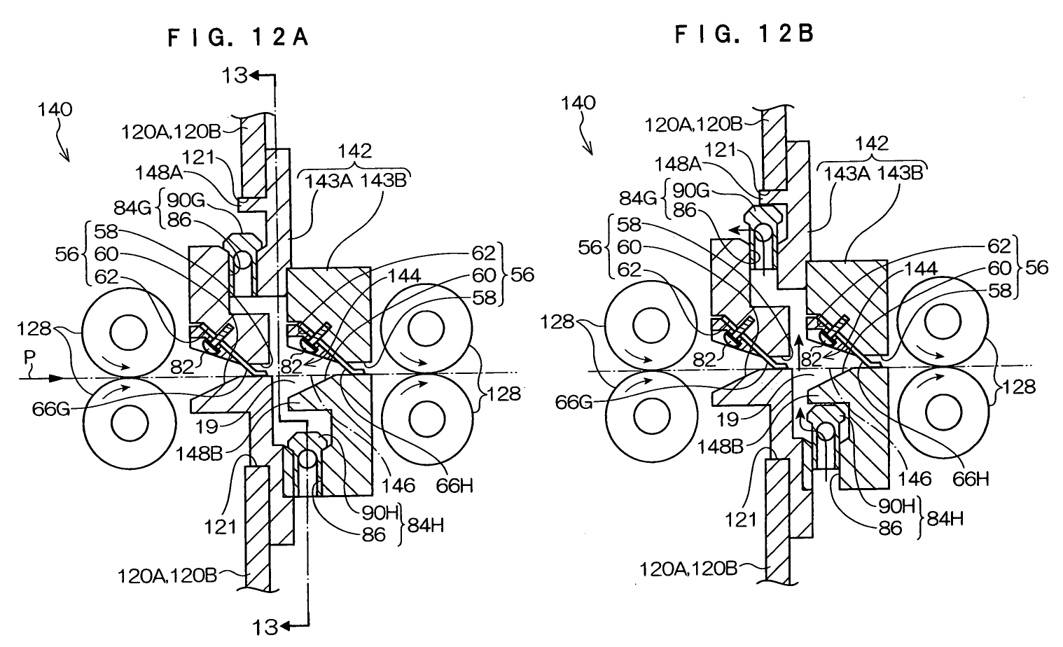

FIG. 12 shows a processing unit with a squeezing function 140 according to a third exemplary embodiment which is to be provided in the abovementioned partition walls 120A and 120B of the washing tank 114 according to the second exemplary embodiment described above.

As shown in FIG. 12A and FIG. 12B, the processing unit 140 includes a housing 142 inside of which is formed a processing space 144 storing the washing water 19. This housing 142 is fitted into an opening 121 formed in the partition walls 120A and 120B, and detachably attached thereto.

The housing 142 is constituted by a combination of a carry-in side housing member 143A arranged on the upstream side (carry-in side/left side) in the conveyance direction of the photosensitive material P, and a carry-out side housing member 143B arranged on the downstream side (carry-out side/right side) in the conveyance direction.

The carry-in side housing member 143A and carry-out side housing member 143B are respectively formed with a conveyance path 146 which enables the photosensitive material P to pass to the right along the horizontal direction being the conveyance direction of the photosensitive material P by the convey rollers 128, in communication with a processing space 144.

This conveyance path 146 has the same structure as that of the conveyance path 56 provided in the processing units 50 and 100 of the first exemplary embodiment. That is, it includes: a slit hole 58, a guide surface portion 60, and a blade attachment surface portion 62. To the blade attachment surface portion 62 are attached blades 66G and 66H having the same structure as that of the first exemplary embodiment, by the blade fixing member 74 and the screws 82. By these blades 66G and 66H, in the slit hole 58 of the respective conveyance paths 146 of the carry-in side housing member 143A and the carry-out side housing member 143B, the photosensitive material P can pass in the conveyance direction, while between the first processing chamber 122 to the third processing chamber 126 and the processing space 144 is liquid-tightly sealed.

Moreover, in the carry-in side housing member 143A is provided a check valve 84G as a processing liquid changing device on the flow-out side, which is for circulating the washing water 19 in the orthogonal direction (upward) to the conveyance direction of the photosensitive material P so as to be flown out from the processing space 144. In the carry-out side housing member 143B is provided a check valve 84H as a processing liquid changing device on the flow-in side, which is for circulating the washing water 19 in the orthogonal direction (upward) to the conveyance direction of the photosensitive material P so as to be flown into the processing space 144.

Similarly to the check valves 84A to 84D of the processing units 50 and 100 of the first exemplary embodiment, these check valves 84G and 84H comprise valve holes 86 and valve bodies 90G and 90H. Moreover, in the same way as those of the valve bodies 90A and 90B of the first exemplary embodiment, regarding the valve bodies 90G and 90H, the setting is such that A/B becomes 1.0 or more but 1.5 or less assuming that the relative density thereof is A and the relative density of the washing water 19 is B.

Moreover, in the position in the carry-in side housing member 143A corresponding to the valve body 90G, is formed a stopper portion 148A which enables the raising operation (valve opening operation) of the valve body 90G while restricting the operation range. In the position in the carry-out side housing member 143B . corresponding to the valve body 90H is formed a stopper portion 148B which enables the raising operation (valve opening operation) of the valve body 90H while restricting the operation range.

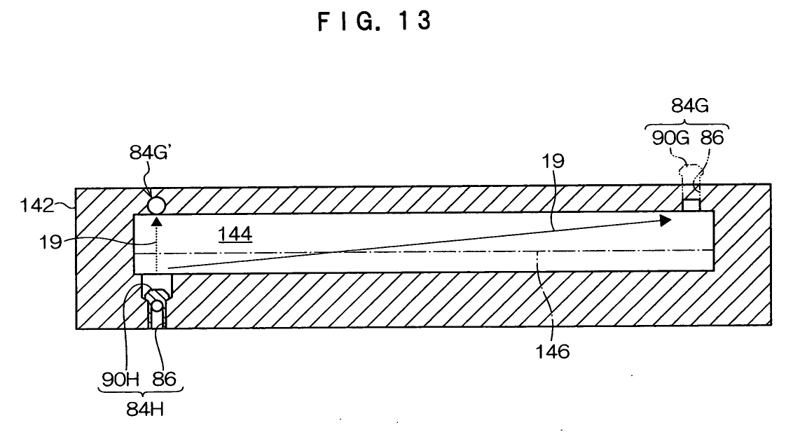

Furthermore, in the processing unit 140 of the present exemplary embodiment, the check valves 84G and 84H are arranged on either side of the conveyance path 146. As shown in FIG. 13, they are arranged in substantially diagonal positions in the cross-sectional longitudinal direction of the conveyance path 146, so that the distance therebetween in the processing space 144 is as long as possible.

These check valves 84G and 84H are opened/closed by the same principle as for the check valves 84A and 84B provided in the processing unit 100 of the first exemplary embodiment. That is, in the check valve 84G, in the case where there is no difference in liquid pressure between the processing space 144 and the first processing chamber 122 or the second processing chamber 124, the valve body 90G having a greater relative density than that of the washing water 19 sinks due to gravity to close the valve hole 86 (refer to FIG. 12A). As a result, the washing water 19 can be kept from backflowing from the first processing chamber 122 or the second processing chamber 124 to the processing space 144. Moreover, in the case where the liquid pressure of the processing space 144 becomes greater than that of the first processing chamber 122 or the second processing chamber 124, the valve body 90G is pushed up into the washing water 19 in the processing space 134, to open the valve hole 86 through the liquid circulation hole 94 (refer to FIG. 12B). As a result, the valve hole 86 is opened through the liquid circulation hole 94, and the washing water 19 in the processing space 144 passes through the valve hole 86 and the liquid circulation hole 94 and then flows out to the first processing chamber 122 or the second processing chamber 124.

On the other hand, in the check valve 84H, in the case where there is no difference in liquid pressure between the processing space 144 and the second processing chamber 124 or the third processing chamber 126, the valve body 90H having a greater relative density than that of the washing water 19 sinks due to gravity to close the valve hole 86 (refer to FIG. 12A). As a result, the washing water 19 can be kept from backflowing from the processing space 144 to the second processing chamber 124 or the third processing chamber 126. Moreover, in the case where the liquid pressure of the second processing chamber 124 or the third processing chamber 126 becomes greater than that of the processing space 144, the valve body 90H is pushed up into the washing water 19 in the second processing chamber 124 or the third processing chamber 126, to open the valve hole 86 through the liquid circulation hole 94 (refer to FIG. 12B). As a result, the washing water 19 in the second processing chamber 124 or the third processing chamber 126 passes through the valve hole 86 and the liquid circulation hole 94 and then flows into the processing space 144.

In this manner, similarly to the processing unit 130 of the second exemplary embodiment, in the processing unit 140 of the present exemplary embodiment having a structure where the washing water 19 is circulated upward at the check valve 84G and 84H, there can be obtained: an effect of improving the washing efficiency with respect to the photosensitive material P; a miniaturization of the apparatus by omitting the number of tanks of the washing tank 114 (number of processing chambers); an effect of reducing the cost by the omission of the number of parts; and an effect of accelerating the agitating and replacement of the washing water 19 in the processing space 144.

Moreover, also in this processing unit 140 applied to the horizontal conveyance system, the arrangement of the check valves of the flow-in side and the flow-out side may be changed such that they are substantially opposed on either side of the conveyance path 146 as with the check valve 84G′ shown in FIG. 13.

As mentioned above, the present invention is described in detail by the first to third exemplary embodiments, however these exemplary embodiments are not to be considered as limiting the present invention, and other various forms can be realized without departing from the scope of the present invention.

For example, the check valve in the abovementioned exemplary embodiments is designed to be openable/closable by an arrangement where the relationship between the relative density of the valve body and the relative density of the processing liquid (washing water) is set within a predetermined range, and thereby it is moved using the difference in relative density between the valve body and the processing liquid, and the difference in liquid pressure between the upstream side and the downstream side. However, taking into consideration the effect of adherence of dirt due to long term usage, the value is preferably set so that the valve body can be reliably moved within the above range.

Moreover, as to the processing liquid changing device for exchanging the processing liquid stored in the processing space of the processing unit, it is not limited to the above check valve, and there may be used for example a pipe structure such as a liquid inlet pipe and a liquid outlet pipe communicated in the processing space, or a membrane member which enables the processing liquid to be circulated. As to the membrane member used for this processing liquid changing device, there may be used a porous-membrane, an ultrafiltration membrane, an ion-exchange membrane, a membrane filter, a microfilter, or the like.

In the above exemplary embodiments, the number of the processing liquid changing devices (check valves) is one per each of the flow-in side and the flow-out side arranged on either side of the conveyance path, however plural devices may be respectively provided for each.

The present invention is not limited to the color processing described above, and may be applied to a photosensitive material processing apparatus for black and white processing including a fixing tank storing a fixing liquid for black and white development.

What is claimed is:

1. A photosensitive material processing apparatus comprising:
a processing tank storing a processing liquid for processing a photosensitive material;
a plurality of processing chambers that are provided in the processing tank and sectioned by partition wall(s);
a housing provided in the partition wall(s);
a processing space that is provided inside the housing and that is communicated with the processing chambers through a conveyance path along which the photosensitive material is passed and conveyed, the processing space storing the processing liquid;
a pair of seal units which are respectively provided on a photosensitive material carry-in side and on a photosensitive material carry-out side of the conveyance path, and which provide a liquid-tight seal between the processing space and the processing chambers, while enabling the photosensitive material to pass through;
a flow-in side processing liquid exchange unit that is provided at the housing, and that enables the processing liquid to flow-in from the processing chamber to the processing space, in order to exchange the processing liquid stored in the processing space;
a flow-out side processing liquid exchange unit that is provided at the housing, and that enables the processing liquid to flow-out from the processing space to the processing chamber, in order to exchange the processing liquid stored in the processing space; and
the flow-in and flow-out side processing liquid exchange units being arranged one on each side of the conveyance path.

2. The photosensitive material processing apparatus according to claim 1, wherein the processing liquid exchange units of the flow-in and flow-out sides are arranged in substantially diagonal positions of the cross-sectional longitudinal direction of the conveyance path.

3. The photosensitive material processing apparatus according to claim 1, wherein the flow direction of the processing liquid at the processing liquid exchange units is substantially parallel to the conveyance direction in which the photosensitive material is conveyed on the conveyance path.

4. The photosensitive material processing apparatus according to claim 2, wherein the flow direction of the processing liquid at the processing liquid exchange units is substantially parallel to the conveyance direction in which the photosensitive material is conveyed on the conveyance path.

5. The photosensitive material processing apparatus according to claim 1, wherein the flow direction of the processing liquid /at the processing liquid exchange units is substantially orthogonal to the conveyance direction in which the photosensitive material is conveyed on the conveyance path.

6. The photosensitive material processing apparatus according to claim 2, wherein the flow direction of the processing liquid at the processing liquid exchange units is substantially orthogonal to the conveyance direction in which the photosensitive material is conveyed on the conveyance path.

7. The photosensitive material processing apparatus according to claim 1, wherein the processing liquid exchange units are check valves.

8. The photosensitive material processing apparatus according to claim 2, wherein the processing liquid exchange units are check valves.

9. The photosensitive material processing apparatus according to claim 3, wherein the processing liquid exchange units are check valves.

10. The photosensitive material processing apparatus according to claim 5, wherein the processing liquid exchange units are check valves.

11. The photosensitive material processing apparatus according to claim 7, wherein a valve body of the check valves is urged onto a valve seat, by a force generated due to a difference in specific gravity of the valve body to that of the processing liquid, to be closed; and separates from the valve seat due to a difference in liquid pressure between the upstream side and the downstream side, to be opened.

12. The photosensitive material processing apparatus according to claim 11, wherein, if the processing liquid is circulated upward through the check valve, specific gravities are set such that A/B is 1.0 or more but less than 1.5 wherein the specific gravity of the valve body is A and the specific gravity of the processing liquid is B.

13. The photosensitive material processing apparatus according to claim 11, wherein, if the processing liquid is circulated downward through the check valve, specific gravities are set such that A/B is 0.6 or more but 1.0 or less assuming that the specific gravity of the valve body is A and the specific gravity of the processing liquid is B.

14. The photosensitive material processing apparatus according to claim 11, wherein, the conveyance direction of the photosensitive material is substantially horizontal, and the flow direction at the check valves is substantially vertical; and when the processing liquid flows downward through the check valves, the flow-out side valve body is arranged downward with respect to the flow-in side valve body and on the other side of the conveyance path.

15. The photosensitive material processing apparatus according to claim 13, wherein specific gravities are set such that A/B is 0.6 or more but less than 1.0 wherein the specific gravity of the valve body is A and the specific gravity of the processing liquid is B.

16. A photosensitive material processing apparatus comprising:
a processing tank storing a processing liquid for processing a photosensitive material;
a plurality of processing chambers that are provided in the processing tank and sectioned by partition wall(s);
a housing provided in the partition wall(s);
a processing space that is provided inside the housing and that is communicated with the processing chambers through a conveyance path along which the photosensitive material is passed and conveyed, the processing space storing the processing liquid;
a pair of seal units which are respectively provided on a photosensitive material carry-in side and on a photosensitive material carry-out side of the conveyance path, and which provide a liquid-tight seal between the processing space and the processing chambers, while enabling the photosensitive material to pass through;
a flow-in side processing liquid exchange unit of a that is provided at the housing, and that enables the processing liquid to flow-in from the processing chamber to the processing space, in order to exchange the processing liquid stored in the processing space; a flow-out side processing liquid exchange unit of a that is provided at the housing, and that enables the processing liquid to flow-out from the processing space to the processing chamber, in order to exchange the processing liquid stored in the processing space;
the flow-in and flow-out side processing liquid exchange units are arranged one on each side of the conveyance path;
the flow-in and flow-out side processing liquid exchange units are arranged in substantially diagonal positions of the cross-sectional longitudinal direction of the conveyance path;
the flow direction of the processing liquid at the processing liquid exchange units is substantially parallel to or substantially orthogonal to the conveyance direction in which the photosensitive material is conveyed on the conveyance path;
the processing liquid exchange units are check valves, and the valve body of the check valves is urged onto a valve seat, by a force generated due to a difference in specific gravity of the valve body to that of the processing liquid, to be closed; and separates from the valve seat due to a difference in liquid pressure between the upstream side and the downstream side, to be opened;
if the processing liquid is circulated upward through the check valve, specific gravities are set such that A/B is 1.0 or more but less than 1.5, or 0.6 or more but less than 1.0, wherein the specific gravity of the valve body is A and the specific gravity of the processing liquid is B; and
the conveyance direction of the photosensitive material is substantially horizontal, and the flow direction at the check valves is substantially vertical, and when the processing liquid flows downward through the check valves, the valve body of the flow-out side is arranged downward with respect to the valve body of the flow-in side and on the other side of the conveyance path.
